(19) United States
(12) Patent Application Publication
(10) Pub. No.: US 2010/0073625 A1
(43) Pub. Date: Mar. 25, 2010

(54) Folding glasses and enclosure

(76) Inventor: John A. Engstrom, Santa Ana, CA (US)

Correspondence Address: Morland C. Fischer, Suite 1300, 2030 Main Street, Invine, CA, 92614, US

(21) Appl. No.: 12/284,730

(22) Filed: Sep. 25, 2008

(51) Int. Cl. G02C 5/08; G02C 11/00

(52) U.S. Cl. 351/63; 351/158

(57) ABSTRACT

Glasses of the kind to be worn for reading and including a pair of optical lenses to be positioned over the eyes of a wearer, first and second frame ends surrounding respective ones of the lenses, and a flexible bridge extending between the first and second frame ends. According to a preferred embodiment, the flexible bridge enables the first and second frame ends to be rotated toward one another, whereby the optical lenses will be aligned one above the other to create a space-efficient folded glasses configuration suitable for storage and transport in a compact enclosure. By way of example, the flexible bridge extending between the opposing frame ends is one of a wire having a spring memory, a coil spring, or a hinge. A handle is attached to one of the frame ends to receive a pushing or a pulling force to enable the wearer to slide his glasses, in their folded configuration, into the compact enclosure or to remove the glasses from the enclosure at which time the glasses will automatically return (i.e., expand) to their normal unfolded configuration ready for use.

### BACKGROUND OF THE INVENTION

1. Field of the Invention

Folding glasses are disclosed of the type to be used from time-to-time for reading. A flexible bridge extends between a pair of optical lenses to permit the glasses to be manipulated to a space-efficient folded configuration at which to be removably received for storage and transport within a compact enclosure.

2. Background Art

Depending upon his circumstances, a wearer may need to have available a pair of glasses to be worn from time-to-time for reading when his existing eyesight or a primary pair of distance glasses is ineffective. That is to say, the wearer will be required to carry with him or have ready access to a pair of reading glasses that will only be worn on a short-time basis. Sometimes, because of its size, there is no place on the wearer's person at which to easily carry a pair of reading glasses. Other times, the wearer may simply forget to carry his reading glasses. Consequently, the wearer will be deprived of the benefit of having with him on a regular basis a pair of glasses to be worn on those occasions when small print must be read.

Therefore, what is desirable is a pair of (e.g., reading) glasses that can be folded in a space-efficient configuration for receipt within a compact enclosure that is suitable to be conveniently and non-obtrusively carried on a regular basis in the wearer's shirt pocket, pants pocket, purse, key chain, and the like.

### SUMMARY OF THE INVENTION

Folding glasses are disclosed having particular application for reading. The folding glasses include a pair of optical lenses, a first frame end surrounding at least some of a first of the pair of lenses, and a second frame end surrounding at least some of the other lens. A flexible bridge extends between the first and second frame ends. By virtue of the flexible bridge, the frame ends can be manipulated from an unfolded configuration, at which the pair of lenses are axially-aligned with one another to cover the eyes of a wearer, to a folded configuration, at which the first and second frame ends are rotated towards one another so that the pair of lenses are positioned one above the other. By way of example only, the flexible bridge extending between the first and second frame ends has a spring memory. In this case, the flexible bridge may be one of a wire manufactured from spring steel or a coil spring that is bent (i.e., stressed) when the frame ends are rotated to the folded configuration. By way of an additional example, the flexible bridge includes a hinge around which the frame ends are rotated to the folded configuration.

With the first and second frame ends rotated to the folded configuration, the glasses will be sized to fit and be transported within a compact enclosure. The enclosure allows the folded glasses to be conveniently and non-obtrusively carried on a regular basis in the wearer's shirt pocket, pants pocket, purse, and the like. A ring attached to the enclosure facilitates coupling the enclosure to a key chain or a key ring. In this manner, the glasses will be carried along with the wearer's keys so as not to be easily forgotten and left behind.

### BRIEF DESCRIPTION OF THE DRAWINGS

FIG. 1 shows folding glasses according to a preferred embodiment of this invention disposed in a folded configuration and located within a compact enclosure;

FIG. 2 shows the folding glasses being removed from the compact enclosure of FIG. 1 in the folded configuration;

FIG. 3 shows the folding glasses in an unfolded configuration ready to wear;

FIG. 4 shows details of one example of a flexible bridge located between first and second frame ends of the folding glasses;

FIG. 5 shows details of another example of a flexible bridge located between the first and second frame ends of the folding glasses; and

FIG. 6 shows the folding glasses disposed in a folded configuration for removable receipt within a key case.

### DESCRIPTION OF THE PREFERRED EMBODIMENT

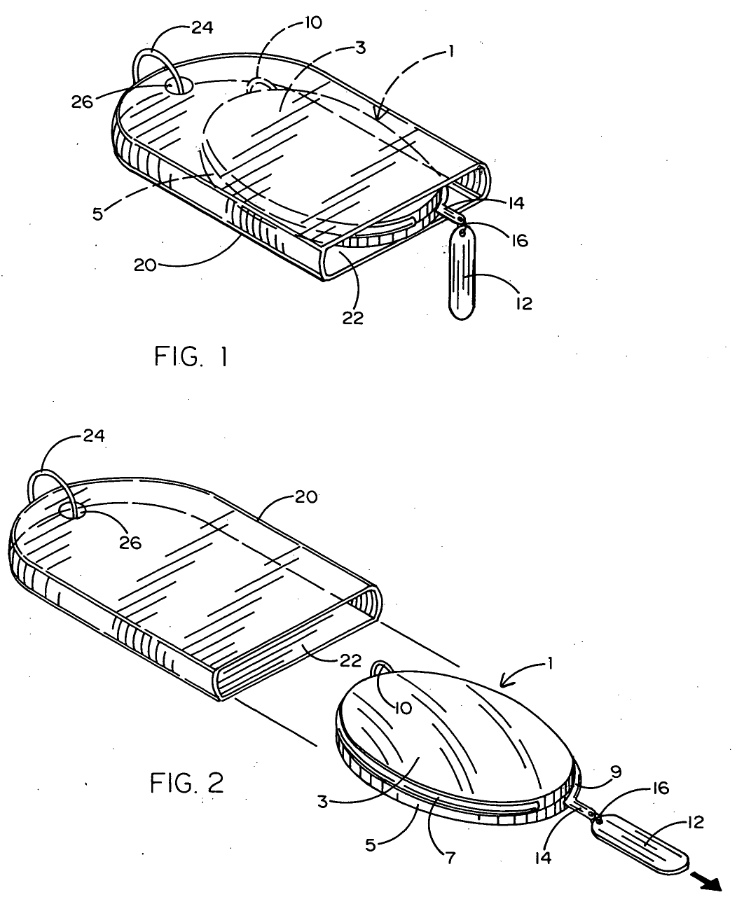

Folding glasses 1 according to a preferred embodiment of this invention are initially described while referring to FIGS. 1-3 of the drawings. The folding glasses 1 illustrated in the drawings are typically those such as reading glasses of the kind that are required from time-to-time for reading small print. However, it is to be understood that the improvement described herein is not limited to any particular type of glasses and is applicable to other types, such as sun-blocking glasses, distance glasses, and the like.

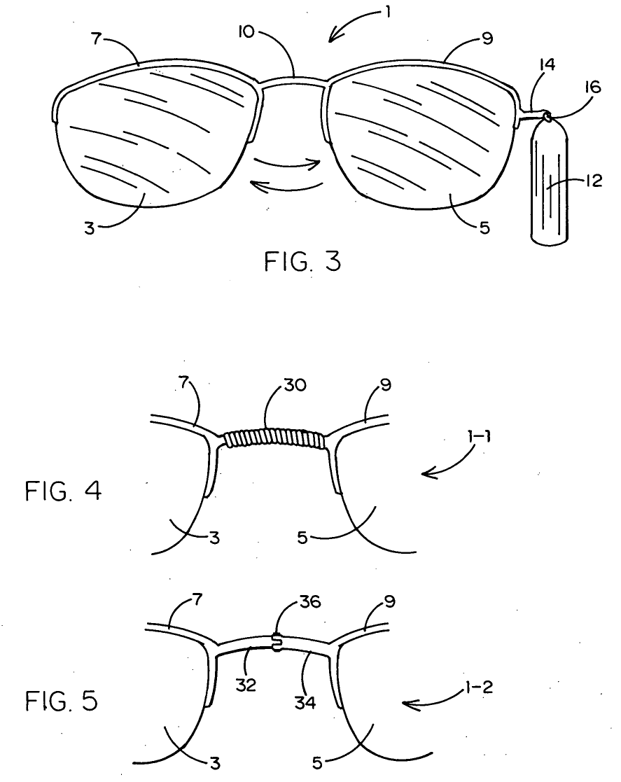

As is best shown in FIG. 3, the folding glasses 1 herein disclosed include a pair of optical lenses 3 and 5 that are spaced axially from one another and surrounded by respective frame ends 7 and 9. A bridge 10 is connected between the frame ends 7 and 9 so that a continuous support is provided for the pair of lenses 3 and 5. As in conventional glasses, the opposing frame ends 7 and 9 and the bridge 10 extending therebetween are sized and shaped to be seated upon the nose of the wearer so that the lenses 3 and 5 of the folding glasses 1 will be positioned over the wearer's eyes.

However, unlike conventional glasses, the folding glasses 1 are devoid of the usual arms that are pivotally coupled to the frame ends 7 and 9 to rest upon respective ones of the wearer's ears. By avoiding the arms, and as will soon be explained, the folding glasses 1 may be more easily stored and transported in a space efficient folded configuration within a compact enclosure (designated 20 in FIGS. 1 and 2). In place of the traditional arms, the folding glasses 1 include a short handle 12 by which to enable the wearer to easily manipulate the glasses into and out of the aforementioned enclosure 20. The handle 12 is attached to one of the frame ends (e.g., 9) by means of a relatively short (e.g., 5 mm) frame extension 14. The handle 12 can be fixedly connected to the frame extension 14 or, in the alternative, pivotally connected thereto by means of a suitable fastener (e.g., a rivet) 16. In this case, the handle 12 will be rotatable relative to the lenses 3 and 5 to enable the wearer to either remove the folding glasses 1 from the enclosure 20 and/or hold the glasses upon his nose for occasional use depending upon the optical characteristics of lenses 3 and 5 and the needs of the wearer.

In accordance with an important feature of this invention, the opposing frame ends 7 and 9 are capable of being folded towards one another to establish the aforementioned space-efficient configuration suitable for storage and transport within the enclosure 20 when use of the lenses 3 and 5 is not required. The foregoing folding capability is achieved by the bridge 10 between frame ends 7 and 9 having a flexible characteristic. By way of a first example, and continuing to refer to FIGS. 1-3, the flexible bridge 10 between frame ends 7 and 8 is a wire that is manufactured from spring steel so as to have a spring memory. In this case, the frame ends 7 and 9 of folding glasses 1 are preferably manufactured from metal or a metal allow to enable the flexible wire bridge 10 to be reliably connected therebetween.

By virtue of its flexible nature, the wire bridge 10 will be stressed and bent by the wearer when the opposing frame ends 7 and 9 are rotated downwardly and towards one another (in the direction of the reference arrows of FIG. 3) so that the lens 5 will lie under and against the lens 3 (best shown in FIG. 2). The wearer may then grasp the folded lenses 3 and 5 and apply a pushing force thereto so as to cause his glasses 1, in the space-efficient folded configuration, to slide inwardly of the enclosure 20 (best shown in FIG. 1) for storage and transport.

The enclosure 20 is preferably manufactured from a material (e.g., vinyl or cloth) that will not scratch the lenses 3 and 5 carried therewithin. The enclosure 20 has an open end 22 within which to receive the glasses 1 in the folded configuration in response to a pushing force applied thereto. In this same regard, whenever they are needed, the glasses 1 can be removed from the open end 22 of enclosure 20 in response to a pulling force applied to handle 12 (represented by the reference arrow in FIG. 2). The spring memory of the wire bridge 10 will cause the glasses 1 to automatically expand from the aforementioned folded configuration to their initial unfolded configuration (of FIG. 3) with the lenses 3 and 5 separated from and axially aligned with one another by which to cover the eyes of the wearer.

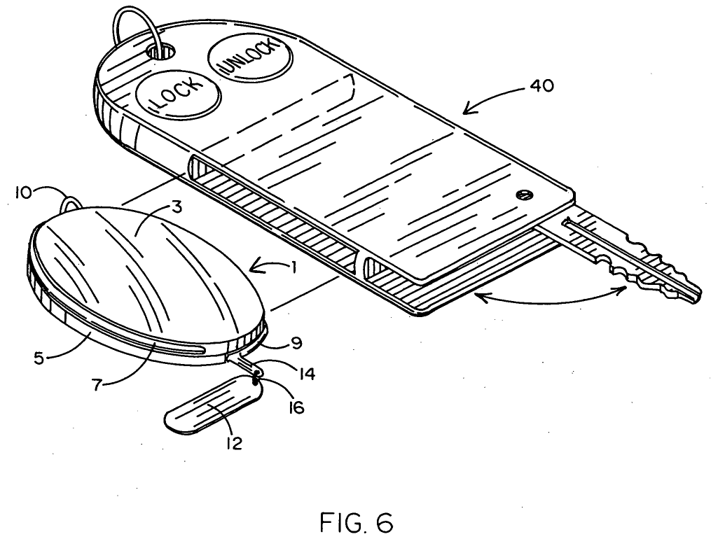

Ideally, the enclosure 20 is a small case or pouch having a flexible characteristic so as to be adapted to expand around and prevent the glasses 1 in the folded configuration from accidentally sliding outwardly through the open end 22. In the alternative, the enclosure 20 may have an inflexible, rigid construction to retain the folded glasses 1 therein by means of friction. By way of example, and as is best shown in FIG. 6 of the drawings, the enclosure may be a molded plastic key case 40 in which the key for operating a motor vehicle is carried. The enclosure 20 holds the glasses 1 in the folded configuration of FIGS. 1 and 2 so as to overcome the normal bias and spring memory of the bent wire bridge 10 to regain its normal unstressed shape and thereby automatically return the folded glasses 1 to their unfolded configuration of FIG. 3. The enclosure 20 allows the glasses 1 in their folded configuration to be conveniently and non-obtrusively carried on a regular basis in the wear's shirt pocket, pants pocket, purse, etc.

A ring 24 is carried by an end of the enclosure 20 that lies opposite the open end 22. The ring 24 is attached to enclosure 20 at a hole 26 formed therethrough. The ring 24 provides the wearer with the advantage of being able to carry small articles (e.g., a key) alongside the enclosure 20. In addition, the ring 24 enables the enclosure 20 to be coupled to a key chain or a key ring. In this manner, the wearer will advantageously be able to carry a pair of reading glasses along with his house keys or car keys such that the glasses will not be easily forgotten and left behind.

Alternative preferred embodiments by which to enable the opposing frame ends 7 and 9 to be rotated to the folded configuration of FIGS. 1 and 2 are now described while referring to FIGS. 4 and 5 of the drawings. In FIG. 4, the bridge extending between the opposing frame ends 7 and 9 of the folding glasses 1-1 is a flexible coil spring 30. Coil spring 30 is preferably manufactured from metal. Like the flexible wire bridge 10 of FIG. 3, the flexible coil spring 30 will be stressed and bent when the opposing frame ends 7 and 9 are rotated downwardly and towards one another so that the lens 5 will lie under and against the lens 3. The glasses 1-1 of FIG. 4 in the folded configuration (not shown) can be slidably received by the previously-described compact enclosures 20 and 40 of FIGS. 1 and 6 for storage and transport. The enclosure 20 or 40 holds the glasses 1 in their folded configuration and overcomes the normal bias and memory of the flexible coil spring 30 to return to its normal unstressed configuration of FIG. 4.

In FIG. 5, the bridge extending between the opposing frame ends 7 and 9 of the folding glasses 1-3 includes a hinge having a pair of interlocking complementary hinge members 32 and 34 that are pivotally coupled together by means of a hinge pin 36. In this case, the interlocking hinge members 32 and 34 and the corresponding frame ends 7 and 9 from which the hinge ends depend are rotatable around the hinge pin 36 to achieve a folded configuration with the lenses 3 and 5 arranged back-to-back one another such that the glasses 1-3 will be sized for slidable receipt by and transport within the compact enclosures 20 and 40 of FIGS. 1 and 6.

1. Folding glasses comprising:
first and second lenses;
a first frame end located in surrounding engagement with at least some of the first lens;
a second frame end located in surrounding engagement with at least some of the second lens; and
a bridge extending between said first and second frame ends, said bridge being flexible such that said frame ends are adapted to be manipulated from an unfolded configuration, at which said first and second lenses are axially aligned with one another to cover the eyes of a wearer, to a folded configuration, at which said first and second frame ends are rotated towards one another and said first and second lenses are positioned one above the other.

2. The folding glasses recited in claim 1, wherein said flexible bridge has a spring memory.

3. The folding glasses recited in claim 1, wherein said flexible bridge is adapted to bend in response to a bending force applied thereto for causing said first and second frame ends to be rotated towards one another to said folded configuration.

4. The folding glasses recited in claim 1, wherein said flexible bridge is a flexible metal wire.

5. The folding glasses recited in claim 4, wherein said flexible metal wire is manufactured from spring steel.

6. The folding glasses recited in claim 1, wherein said flexible bridge is a spring.

7. The folding glasses recited in claim 6, wherein said spring is a coil spring.

8. The folding glasses recited in claim 1, wherein said flexible bridge includes a hinge.

9. The folding glasses recited in claim 1, wherein said flexible bridge includes interlocking first and second hinge members and a hinge pin by which first and second hinge members are pivotally coupled together and rotatable relative to one another when said first and second frame members are manipulated between the folded and unfolded configurations.

10. A combination comprising:
first and second optical lenses;
a first frame end located in surrounding engagement with at least some of said first optical lens;
a second frame end located in surrounding engagement with at least some of said second optical lens;
a flexible bridge extending between said first and second frame ends such that said frame ends are adapted to be manipulated from an unfolded configuration, at which said first and second lenses are axially aligned with one another to cover the eyes of a wearer, to a folded configuration, at which said first and second frame ends are rotated towards one another and said first and second lenses are positioned one above the other; and
an enclosure for removably receiving and retaining said first and second frame ends in said folded configuration.

11. The combination recited in claim 10, further comprising a ring attached to and carried by said enclosure.

12. The combination recited in claim 10, further comprising a handle extending from one of said first and second frame ends, said handle receiving a pushing or pulling force for correspondingly causing said frame ends in the folded configuration to be received by or removed from said enclosure.

13. The combination recited in claim 12, wherein said handle is pivotally coupled to the one of said first and second frame ends so as to be rotatable relative thereto.

14. The combination recited in claim 10, wherein said flexible bridge has a spring memory, said flexible bridge bending in response to a rotational force applied thereto for causing said first and second frame ends to move from said unfolded configuration to said folded configuration.

15. The combination recited in claim 10, wherein said flexible bridge includes a hinge.

16. The combination recited in claim 10, wherein said enclosure is a key case in which a key is carried.
